(19) United States
(12) Patent Application Publication
(10) Pub. No.: US 2019/0364939 A1
(43) Pub. Date: Dec. 5, 2019

(54) PUREED NUTRITIONAL PRODUCT

(71) Applicant: ABBOTT LABORATORIES, Abbott Park, IL (US)

(72) Inventors: ROCKENDRA GUPTA, Columbus, OH (US); GAURAV PATEL, Gahanna, OH (US); NORMANELLA DEWILLE, Columbus, OH (US)

(73) Assignee: ABBOTT LABORATORIES, Abbott Park, IL (US)

(21) Appl. No.: 16/335,619

(22) PCT Filed: Sep. 21, 2017
(86) PCT No.: PCT/US2017/052774

§ 371 Date: Mar. 21, 2019

Related U.S. Application Data
(60) Provisional application No. 62/398,780, filed on Sep. 23, 2016.

(51) Int. Cl. A23L 19/00; A23L 33/12; A23L 33/19; A23L 33/00; B65D 75/00; B65D 75/58; B65D 85/72

(52) U.S. Cl. CPC A23L 19/09; A23L 33/12; A23L 33/19; A23V 2002/00; B65D 75/008; B65D 75/5883; B65D 85/72; A23L 33/40

(57) ABSTRACT

A pureed nutritional product, a packaged nutritional product containing a pureed nutritional product, and a method of making the pureed nutritional product are provided. The pureed nutritional product includes from 50 wt % to 99.7 wt % of a blend of fruit and vegetable, at least one polyunsaturated fatty acid, at least one carotenoid, and RRR-alpha-tocopherol. The pureed nutritional product has an energy density of 0.4 kcal/g to 0.8 kcal/g. The pureed nutritional product has desirable consistency, texture, and mouthfeel characteristics.

### CROSS REFERENCE TO RELATED APPLICATIONS

This application is the U.S. national stage entry of International Application No. PCT/US2017/052774, filed Sep. 21, 2017, which claims priority to and the benefit of U.S. Provisional Patent Application No. 62/398,780, filed Sep. 23, 2016, the entire contents of which are incorporated by reference herein.

### FIELD

The present disclosure relates to pureed nutritional products and methods of making pureed nutritional products. More particularly, the present disclosure relates to pureed nutritional products that have improved consistency, texture, and mouthfeel.

### BACKGROUND

Proper nutrition is generally regarded as one of the key factors for achieving and maintaining good health. This is particularly true for infants and children as they grow and develop. The U.S. Department of Agriculture recommends that children (aged 2-8) consume 1 to 1½ cups (237 to 355 ml) of fruit per day and 1 to 1½ cups (237 to 355 ml) of vegetables per day. However, many children fall short of the recommended daily intake of fruits and vegetables. Children can be picky eaters and often prefer foods that are rich in simple sugars and starch over fruits and vegetables. Typically, these children-preferred foods are lower in, or completely lack, the essential nutrients needed to support optimal growth and development of children.

### SUMMARY

Disclosed herein are pureed nutritional products, packaged nutritional products containing a pureed nutritional product, and methods of making pureed nutritional products. To illustrate various aspects of the present disclosure, several exemplary embodiments of pureed nutritional products, packaged nutritional products containing a pureed nutritional product, and methods of making the pureed nutritional products are provided herein.

In one exemplary embodiment, a pureed nutritional product is provided. The pureed nutritional product includes from 50 wt % to 99.7 wt % of a blend of fruit and vegetable, at least one polyunsaturated fatty acid, at least one carotenoid, and RRR-alpha-tocopherol. The pureed nutritional product has an energy density of 0.4 kcal/g to 0.8 kcal/g.

In certain exemplary embodiments, the at least one polyunsaturated fatty acid comprises docosahexaenoic acid. In certain exemplary embodiments, the pureed nutritional product comprises from 0.1 mg to 0.5 mg of docosahexaenoic acid per gram of pureed nutritional product. In certain exemplary embodiments, the pureed nutritional product has less than 0.12 grams of monosaccharides and disaccharides per gram of pureed nutritional product. In certain exemplary embodiments, the pureed nutritional product includes from 6 mg to 120 mg of protein per gram of pureed nutritional product. In certain exemplary embodiments, the pureed nutritional product has an average particle size of less than 300 μm. In certain exemplary embodiments, 90% of the particles comprising the pureed nutritional product have a particle size of less than 600 μm. In certain exemplary embodiments, the pureed nutritional product has a consistency of 5 cm to 15 cm per 30 seconds as determined by a consistometer.

In one exemplary embodiment, a packaged nutritional product is provided. The packaged nutritional product includes a sealed container having an interior volume and a pureed nutritional product disposed within the interior volume of the container. The pureed nutritional product includes from 50 wt % to 99.7 wt % of a blend of fruit and vegetable, at least one polyunsaturated fatty acid, at least one carotenoid, and RRR-alpha-tocopherol. The pureed nutritional product has an energy density of 0.4 kcal/g to 0.8 kcal/g.

In one exemplary embodiment, a method of making a pureed nutritional product is provided. The method includes mixing together at least one polyunsaturated fatty acid, at least one carotenoid, and RRR-alpha-tocopherol with a first portion of a fruit or a vegetable to form a pre-blend. The pre-blend is mixed together with a blend of a second portion of fruit and vegetable to form the pureed nutritional product. The method also includes homogenizing the pureed nutritional product to reduce the particle size of the pureed nutritional product. The pureed nutritional product can be packaged using hot-fill, retort, or aseptic processing methods.

### BRIEF DESCRIPTION OF THE DRAWINGS

FIG. 1 shows an embodiment of a packaged nutritional product according to the present disclosure.

FIG. 2 is a graph of the coefficient of friction as a function of sliding speed for a homogenized pureed nutritional product and a non-homogenized pureed nutritional product.

FIG. 3 is a graph of the particle size distribution for a homogenized pureed nutritional product and a non-homogenized pureed nutritional product.

### DETAILED DESCRIPTION

Disclosed herein are pureed nutritional products, packaged nutritional products containing a pureed nutritional product, and methods of making pureed nutritional products. While the present disclosure describes certain embodiments of the products and methods in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

The pureed nutritional products, packaged nutritional products, and corresponding methods of making the pureed nutritional products of the present disclosure can comprise, consist of, or consist essentially of the essential elements of the disclosure as described herein, as well as any additional or optional element described herein or which is otherwise useful in nutritional supplement applications.

All percentages, parts, and ratios as used herein are by weight of the total formulation, unless otherwise specified. All such weights as they pertain to listed ingredients are based on the active level and, therefore, do not include solvents, by-products, or other components that may be included in commercially available materials, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The terms “puree” or “pureed” as used herein refers to a fruit, a vegetable, or a combination thereof that has been mashed, pressed, blended, crushed, or otherwise broken down so that it has the texture of a semi-liquid or paste.

The term “concentrate” as used herein refers to a fruit juice or a vegetable juice where most or all of the water has been removed.

The term “sugar” as used herein, unless otherwise specified, refers to monosaccharides (e.g., glucose, fructose), disaccharides (e.g., sucrose, lactose), and combinations thereof.

Pureed nutritional products according to the present disclosure comprise from 50 wt % to 99.7 wt % of a blend of fruit and vegetable (based on the total weight of the pureed nutritional product), at least one polyunsaturated fatty acid, at least one carotenoid, and RRR-alpha-tocopherol. The pureed nutritional products have an energy density of 0.4 kcal/g to 0.8 kcal/g. The pureed nutritional products have a desirable consistency, texture, and mouthfeel, and also provide at least three toddler servings of combined fruits and vegetables per serving of the pureed nutritional product. As used herein, a “toddler serving” of a fruit or a vegetable refers to a one-fourth cup serving of a fruit or a vegetable according to the U.S. Department of Agriculture's recommended serving amount of a particular fruit or a particular vegetable per cup of the particular fruit or the particular vegetable. For example, a one cup serving of spinach is equivalent to 30 grams of spinach. A serving of 7.5 grams of spinach is equivalent to a one-fourth cup serving of spinach, or one toddler serving of vegetable in terms of spinach. Accordingly, the pureed nutritional products can be used to supplement the fruit and vegetable intake of an individual, particularly toddlers (ages 1-3) and children (ages 4-8) who may not typically consume the recommended daily serving of fruits and vegetables.

Embodiments of the pureed nutritional product described herein comprise from 50 wt % to 99.7 wt % of a blend of fruit and vegetable, based on the total weight of the pureed nutritional product. In certain embodiments, the pureed nutritional product comprises from 60 wt % to 99.7 wt % of a blend of fruit and vegetable, including from 70 wt % to 99.7 wt % of a blend of fruit and vegetable, from 80 wt % to 99.7 wt % of a blend of fruit and vegetable, from 90 wt % to 99.7 wt % of a blend of fruit and vegetable, from 95 wt % to 99.7 wt % of a blend of fruit and vegetable, and also including from 98 wt % to 99.7 wt % of a blend of fruit and vegetable, based on the total weight of the pureed nutritional product.

A wide variety of fruits and vegetables may be used in the exemplary pureed nutritional product described herein. Exemplary fruits suitable for use in the pureed nutritional product include, but are not limited to, apple, banana, blueberry, mango, pear, strawberry, pineapple, avocado, peach, and lemon. Exemplary vegetables suitable for use in the pureed nutritional product include, but are not limited to, squash, sweet potato, carrot, pumpkin, spinach, kale, broccoli, and zucchini. The fruits and vegetables that are used in the pureed nutritional product may be in the form of a puree, a concentrate, or a combination thereof. In certain embodiments, the fruits and vegetables used in the pureed nutritional product may be certified USDA organic or non-organic. Regardless of the initial form of the fruits and vegetables, the resulting pureed nutritional product is a puree as defined herein.

In certain embodiments of the pureed nutritional product, the blend of fruit and vegetable comprises apple puree, butternut squash puree, banana puree, and blueberry puree. In certain embodiments, the apple puree comprises from 40 wt % to 50 wt % of the blend of fruit and vegetable, the butternut squash puree comprises from 25 wt % to 35 wt % of the blend of fruit and vegetable, the banana puree comprises from 10 wt % to 20 wt % of the blend of fruit and vegetable, and the blueberry puree comprises from 3 wt % to 13 wt % of the blend of fruit and vegetable. In a preferable embodiment of the pureed nutritional product, the pureed nutritional product comprises about 45 wt % apple puree, about 31 wt % butternut squash puree, about 15 wt % banana puree, and about 8 wt % blueberry puree, based on the total weight of the pureed nutritional product.

In certain embodiments of the pureed nutritional product, the blend of fruit and vegetable comprises mango puree, sweet potato puree, and pear puree. In certain embodiments, the mango puree comprises from 32 wt % to 42 wt % of the blend of fruit and vegetable, the sweet potato puree comprises from 28 wt % to 38 wt % of the blend of fruit and vegetable, and the pear puree comprises from 24 wt % to 34 wt % of the blend of fruit and vegetable. In a preferable embodiment of the pureed nutritional product, the pureed nutritional product comprises about 37 wt % mango puree, about 33 wt % butternut squash puree, and about 29 wt % pear puree, based on the total weight of the pureed nutritional product.

In certain embodiments of the pureed nutritional product, the blend of fruit and vegetable comprises mango puree, apple puree, butternut squash puree, and spinach puree. In certain embodiments, the mango puree comprises from 33 wt % to 43 wt % of the blend of fruit and vegetable, the apple puree comprises from 26 wt % to 34 wt % of the blend of fruit and vegetable, the butternut squash puree comprises from 22 wt % to 28 wt % of the blend of fruit and vegetable, and the spinach puree comprises from 2 wt % to 8 wt % of the blend of fruit and vegetable. In a preferable embodiment of the pureed nutritional product, the pureed nutritional product comprises about 39 wt % mango puree, about 30 wt % apple puree, about 25 wt % butternut squash puree, and about 5 wt % spinach puree, based on the total weight of the pureed nutritional product.

In certain embodiments of the pureed nutritional product, the blend of fruit and vegetable comprises butternut squash puree, pumpkin puree, banana puree, carrot juice concentrate, spinach puree, and broccoli puree. In certain embodiments, the butternut squash puree comprises from 27 wt % to 37 wt % of the blend of fruit and vegetable, the pumpkin puree comprises from 23 wt % to 33 wt % of the blend of fruit and vegetable, the banana puree comprises from 20 wt % to 29 wt % of the blend of fruit and vegetable, the carrot juice concentrate comprises from 3 wt % to 9 wt % of the blend of fruit and vegetable, the spinach puree comprises from 2 wt % to 8 wt % of the blend of fruit and vegetable, and the broccoli puree comprises from 0.5 wt % to 3.5 wt % of the blend of fruit and vegetable. In a preferable embodiment of the pureed nutritional product, the pureed nutritional product comprises about 32 wt % butternut squash puree, about 28 wt % pumpkin puree, about 24 wt % banana puree, about 6 wt % carrot juice concentrate, about 5 wt % spinach puree, and about 2 wt % broccoli puree, based on the total weight of the pureed nutritional product.

The pureed nutritional product may be formulated to have a low sugar content. In certain embodiments, the pureed nutritional product contains less than 0.12 grams of monosaccharides and disaccharides per gram of the pureed nutritional product. In certain embodiments, the pureed nutritional product contains less than 0.11 grams of monosaccharides and disaccharides per gram of the pureed nutritional product, including less than 0.10 grams of monosaccharides and disaccharides per gram of the pureed nutritional product, less than 0.09 grams of monosaccharides and disaccharides per gram of the pureed nutritional product, and also including less than 0.08 grams of monosaccharides and disaccharides per gram of the pureed nutritional product. The low sugar content may be achieved by selecting appropriate types and amounts of fruits and vegetables when formulating the pureed nutritional product. Exemplary low sugar content pureed nutritional products are shown in the examples that follow herein.

The pureed nutritional product may also provide a source of dietary fiber, which is often lacking in the diets of toddlers and children. In certain embodiments, the pureed nutritional product has from 8 mg to 18 mg of fiber per gram of the pureed nutritional product. In certain embodiments, the pureed nutritional product has from 10 mg to 15 mg of fiber per gram of the nutritional product. The particular fiber content of the pureed nutritional product can be achieved by selecting appropriate types and amounts of fruits and vegetables when formulating the pureed nutritional product.

Pureed nutritional products according to the present disclosure have a pleasing consistency, texture, and mouthfeel. The pureed nutritional products do not exhibit the coarse or gritty mouthfeel and non-homogenous appearance associated with conventional pureed products. The desirable consistency, texture, and mouthfeel characteristics of the pureed nutritional products are accomplished by homogenizing the pureed nutritional products to reduce particle size. In certain embodiments, the pureed nutritional product has an average particle size of less than 300 In certain embodiments, at least 90% of particles comprising the pureed nutritional product have a particle size of less than 600 In certain embodiments, at least 90% of particles comprising the pureed nutritional product have a particle size of less than 600 and the pureed nutritional product has an average particle size of less than 300 Such particle size characteristics have been found to impart a smooth texture and mouthfeel to the pureed nutritional product.

In certain embodiments, the pureed nutritional product has a consistency of 5 cm to 15 cm per 30 seconds as determined by a consistometer, such as a Bostwick consistometer. The consistometer device is used to measure the distance a sample flows in a given time interval, which is a quantitative way to measure consistency. In certain embodiments, the pureed nutritional product has a consistency of 6 cm to 12 cm per 30 seconds. When the pureed nutritional product is in a container, such as a flexible pouch with a spout, the consistency of the pureed nutritional product promotes the ability of a toddler or child to easily squeeze the pureed nutritional product out of the container for consumption.

The pureed nutritional products described herein also include at least one polyunsaturated fatty acid. In certain embodiments, the polyunsaturated fatty acid present in the pureed nutritional product includes at least one omega-3 polyunsaturated fatty acid. Exemplary omega-3 polyunsaturated fatty acids suitable for use in the pureed nutritional product include, but are not limited to, docosahexaenoic acid, eicosapentaenoic acid, and alpha-linolenic acid. In certain embodiments, the at least one polyunsaturated fatty acid present in the pureed nutritional product comprises docosahexaenoic acid (DHA). DHA is an omega-3 polyunsaturated fatty acid that supports the growth and functional development of the brain as well as promotes vision development in toddlers and children.

In certain embodiments, the pureed nutritional product includes from 0.1 mg to 0.5 mg of DHA per gram of the pureed nutritional product. In certain embodiments, the pureed nutritional product includes from 0.15 mg to 0.5 mg of DHA per gram of the pureed nutritional product, including from 0.2 mg to 0.45 mg of DHA per gram of the pureed nutritional product, from 0.25 mg to 0.4 mg of DHA per gram of the pureed nutritional product, from 0.25 mg to 0.35 mg of DHA per gram of the pureed nutritional product, and also including from 0.25 mg to 0.3 mg of DHA per gram of the pureed nutritional product. In certain embodiments, the pureed nutritional product includes DHA in an amount so as to provide, per serving, from 20 mg to 50 mg of DHA, including from 20 mg to 45 mg, from 25 mg to 40 mg, and also including from 30 mg to 35 mg of DHA.

It is known that DHA is susceptible to oxidation, which can result in fishy, painty, or otherwise rancid off-flavors and aromas. To provide protection against this oxidation and the resulting off-flavors and aromas, the DHA used in the pureed nutritional product may be an encapsulated DHA. In certain embodiments, the pureed nutritional product comprises encapsulated DHA with antioxidants. In certain embodiments, the pureed nutritional product includes, per serving, from 20 mg to 50 mg of DHA that is provided by encapsulated DHA in powder form.

Embodiments of the pureed nutritional product described herein include at least one carotenoid. Exemplary carotenoids suitable for use in the pureed nutritional product include, but are not limited to, lutein, zeaxanthin, and beta-carotene. In certain embodiments, the at least one carotenoid present in the pureed nutritional product is inherently provided as a component of the blend of fruit and vegetable. In certain embodiments, a portion of the at least one carotenoid present in the pureed nutritional product may be provided by the blend of fruit and vegetable, and the remaining portion of the carotenoids may be provided by free carotenoids, carotenoid salts, carotenoid esters, carotenoid derivatives, and combinations thereof. In certain embodiments, the at least one carotenoid comprises lutein. Lutein functions as an antioxidant and when ingested, it concentrates within the retina of the eye. It is generally known that dietary lutein supports eye health and vision development in toddlers and children.

In certain embodiments, the pureed nutritional product includes from 0.05 mcg to 20 mcg of lutein per gram of the pureed nutritional product. In certain embodiments, the pureed nutritional product includes from 0.25 mcg to 15 mcg of lutein per gram of the pureed nutritional product, including from 0.5 mcg to 10 mcg of lutein per gram of the pureed nutritional product, from 0.75 mcg to 5 mcg of lutein per gram of the pureed nutritional product, from 1 mcg to 5 mcg of lutein per gram of the pureed nutritional product, and also including from 2 mcg to 3 mcg of lutein per gram of the pureed nutritional product. In certain embodiments, the pureed nutritional product includes lutein in an amount so as to provide, per serving, from 10 mcg to 2,000 mcg of lutein, including from 50 mcg to 1500 mcg, from 100 mcg to 1,000 mcg, from 200 mcg to 500 mcg, and also including from 250 mcg to 400 mcg of lutein. In certain embodiments, the lutein present in the pureed nutritional product may be inherently provided as a component of the blend of fruit and vegetable. In certain embodiments, a portion of the lutein present in the pureed nutritional product may be provided by the blend of fruit and vegetable, and the remaining portion of the lutein may be provided by free lutein, lutein esters, lutein salts, lutein derivatives, and combinations thereof. In certain embodiments, all of the lutein present in the pureed nutritional product is provided inherently by the blend of fruit and vegetable. In certain embodiments, more than 25% of the lutein present in the pureed nutritional product is provided by free lutein, lutein esters, lutein salts, other lutein derivatives, and combinations thereof.

The pureed nutritional products described herein also include RRR-alpha-tocopherol. RRR-alpha-tocopherol is the naturally occurring form of vitamin E, which functions as an antioxidant that stabilizes unsaturated lipids in cell membranes against autoxidation and scavenges free radicals produced from lipid peroxidation by the normal activity of oxidative enzymes. The inclusion of RRR-alpha-tocopherol in the pureed nutritional product provides a source of vitamin E that is preferentially absorbed (compared to synthetic vitamin E, dl-alpha-tocopheryl acetate) to support developing cells in toddlers and children.

In certain embodiments, the pureed nutritional product includes from 0.002 mg to 0.06 mg of RRR-alpha-tocopherol per gram of the pureed nutritional product. In certain embodiments, the pureed nutritional product includes from 0.002 mg to 0.06 mg of RRR-alpha-tocopherol per gram of the pureed nutritional product, including from 0.004 mg to 0.05 mg of RRR-alpha-tocopherol per gram of the pureed nutritional product, from 0.006 mg to 0.04 mg of RRR-alpha-tocopherol per gram of the pureed nutritional product, from 0.008 mg to 0.025 mg of RRR-alpha-tocopherol per gram of the pureed nutritional product, and also including from 0.01 mg to 0.015 mg of RRR-alpha-tocopherol per gram of the pureed nutritional product. In certain embodiments, the pureed nutritional product includes RRR-alpha-tocopherol in an amount so as to provide, per serving, from 0.5 IU of vitamin E to 9 IU of vitamin E, including from 0.5 IU of vitamin E to 5 IU of vitamin E, and also including from 1 IU of vitamin E to 3 IU of vitamin E.

In certain embodiments, the pureed nutritional product includes from 0.1 mg to 0.5 mg of DHA per gram of the pureed nutritional product, from 0.05 mcg to 20 mcg of lutein per gram of the pureed nutritional product, and from 0.002 mg to 0.06 mg of RRR-alpha-tocopherol per gram of the pureed nutritional product. In certain embodiments, the pureed nutritional product includes from 0.25 mg to 0.3 mg of DHA per gram of the pureed nutritional product, from 2 mcg to 3 mcg of lutein per gram of the pureed nutritional product, and from 0.01 mg to 0.015 mg of RRR-alpha-tocopherol per gram of the pureed nutritional product.

The pureed nutritional products may be formulated to have different pH values to affect the taste of the products as well as to accommodate various packaging and sterilization methods. In certain embodiments, the pureed nutritional product has a pH of 3.8 to 4.6 (high acid), including a pH of 3.8 to 4.2. A high acid pH facilitates packaging of the pureed nutritional product using a hot-fill method. In certain embodiments, the pureed nutritional product has a pH that is greater than 4.6 (low acid). A pureed nutritional product having a low acid pH will typically require a retort or aseptic processing method to ensure adequate sterilization. In certain embodiments, the pureed nutritional product comprises an acidity regulator. The acidity regulator may be used to lower the pH of the pureed nutritional product, or may be used to raise the pH of the pureed nutritional product. Exemplary acidity regulators suitable for use in the pureed nutritional product include, but are not limited to, lemon juice concentrate, lemon juice, citric acid, ascorbic acid, and lemon juice.

The protein content of fruits and vegetables is typically low, for example, less than 1.5 wt %. To provide supplemental protein, the pureed nutritional products may include a protein ingredient. Suitable protein ingredients for use in the pureed nutritional products described herein include, but are not limited to, whey protein, vegetable proteins (e.g., pea protein, lentil protein), casein protein, and combinations thereof. Preferably, the protein ingredients used in the pureed nutritional products are selected so as to not adversely affect the taste or consistency of the pureed nutritional products.

In certain embodiments, the pureed nutritional product includes whey protein. In certain embodiments, the pureed nutritional product includes whey protein and lentil protein. In certain embodiments, the pureed nutritional product includes whey protein and pea protein. An exemplary whey protein suitable for use in the pureed nutritional product disclosed herein is WPC 550 available from Fonterra Co-operative Group Limited (Auckland, New Zealand). An exemplary lentil protein suitable for use in the pureed nutritional product disclosed herein is Vitessence™ Pulse 2550 available from Ingredion, Inc. (Westchester, Ill.). An exemplary pea protein suitable for use in the pureed nutritional product disclosed herein is HarvestPro™ Pea Protein 85 available from Glanbia Plc (Kilkenny, Ireland).

In certain embodiments, the pureed nutritional product includes from 6 mg to 120 mg of protein per gram of the pureed nutritional product. In certain embodiments, the pureed nutritional product includes from 10 mg to 100 mg of protein per gram of the pureed nutritional product, including from 15 mg to 90 mg of protein per gram of the pureed nutritional product, from 15 mg to 75 mg of protein per gram of the pureed nutritional product, from 20 mg to 50 mg of protein per gram of the pureed nutritional product, from 30 mg to 50 mg of protein per gram of the pureed nutritional, from 6 mg to 60 mg of protein per gram of the pureed nutritional product, from 6 mg to 50 mg of protein per gram of the pureed nutritional product, from 6 mg to 40 mg of protein per gram of the pureed nutritional product, from 6 mg to 30 mg of protein per gram of the pureed nutritional product, and also including from 10 mg to 25 mg of protein per gram of the pureed nutritional product. In certain of the preceding embodiments, at least a portion of the protein is a whey protein. In certain of the preceding embodiments, at least 25% of the protein is whey protein, including at least 30%, at least 40%, at least 50%, and also including at least 75%.

A typical serving of the exemplary pureed nutritional products described herein may be from 100 grams to 150 grams. A preferable serving size of the pureed nutritional product is from 110 grams to 120 grams, and more preferably 114 grams. The typical serving of the exemplary pureed nutritional product provides at least three toddler servings of combined fruits and vegetables, which can help fill the dietary gap of fruits and vegetables often present in the diet of a toddler or child. In certain embodiments, a serving of the pureed nutritional product provides from 60 kcal of energy to 80 kcal of energy.

In certain embodiments, the pureed nutritional products described herein are lactose free, galactose free, gluten free, and do not contain any artificial preservatives, colors, or flavors. In certain embodiments, all of the ingredients of the pureed nutritional product are non-genetically modified, and thus the pureed nutritional product itself is non-genetically modified.

In one exemplary embodiment, a packaged nutritional product is provided. The packaged nutritional product includes a sealed container having an interior volume and a pureed nutritional product disposed within the interior volume of the container. The pureed nutritional product includes from 50 wt % to 99.7 wt % of a blend of fruit and vegetable, at least one polyunsaturated fatty acid, at least one carotenoid, and RRR-alpha-tocopherol, and has an energy density of 0.4 kcal/g to 0.8 kcal/g. Any of the previously described embodiments or features of the pureed nutritional product may be included in the packaged nutritional product.

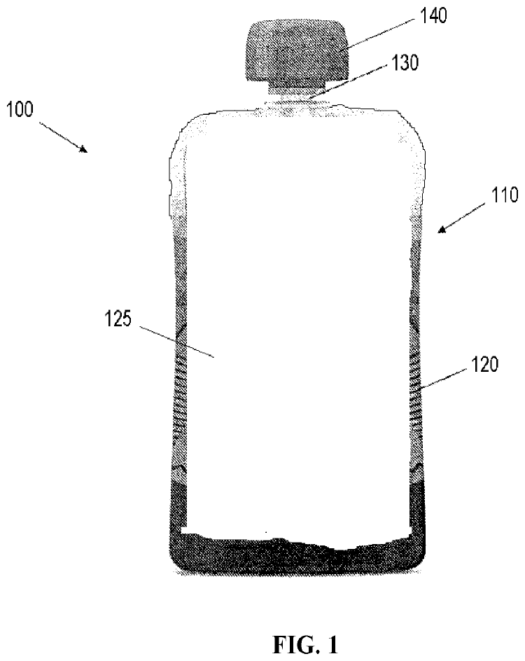

The packaged nutritional product can be provided as a single serving packaged nutritional product or as a multi-serving packaged nutritional product, such as a bulk container having a resealable closure. In certain embodiments, multiple (e.g., two or more) single serving packaged nutritional products can be packaged together in a carton. Referring now to FIG. 1, an exemplary embodiment of a single serving packaged nutritional product 100 is shown. As seen in FIG. 1, the sealed container 110 comprises a flexible pouch 120 having a spout 130 in fluid communication with the interior volume 125 of the flexible pouch 120 and a closure 140 to releasably engage the spout 130. The pureed nutritional product may be consumed directly out of the flexible pouch by squeezing the flexible pouch to force the pureed nutritional product through the spout. In certain embodiments, the closure, such as a cap, may have threads that cooperatively engage threads on an outer surface of the spout to enable selective covering or uncovering of the spout.

Also provided herein is a method of making the exemplary pureed nutritional products disclosed herein. In one exemplary embodiment, a method of making the pureed nutritional product disclosed herein includes mixing together at least one polyunsaturated fatty acid, at least one carotenoid, and RRR-alpha-tocopherol with a first portion of a fruit or a vegetable to form a pre-blend. In certain embodiments, the first portion of a fruit or a vegetable is a fruit or vegetable puree or a concentrated fruit or vegetable juice. In certain embodiments, the at least one polyunsaturated fatty acid, the at least one carotenoid, and the RRR-alpha-tocopherol are in powder form. In certain embodiments, the at least one polyunsaturated fatty acid, at least one carotenoid, and RRR-alpha-tocopherol are mixed with the first portion of a fruit or a vegetable in a liquefier or other suitable industrial blender. In certain embodiments, the at least one polyunsaturated fatty acid, at least one carotenoid, and RRR-alpha-tocopherol are mixed with a banana puree or a mango puree in a liquefier to form the pre-blend. Formation of the pre-blend promotes homogeneity of the at least one polyunsaturated fatty acid, at least one carotenoid, and RRR-alpha-tocopherol in the pureed nutritional product. In certain embodiments, the at least one polyunsaturated fatty acid, at least one carotenoid, and RRR-alpha-tocopherol are mixed with a fruit or a vegetable for 2 minutes to 10 minutes, preferably for 5 minutes, to form the pre-blend.

After the pre-blend is formed, the pre-blend is mixed together with a blend of a second portion of fruit and vegetable to form the pureed nutritional product. Generally, the fruit or vegetable comprising the first portion in the pre-blend will also be a fruit or vegetable that is present in the blend of the second portion of fruit and vegetable. In certain embodiments, the pre-blend is transferred to a blend tank or other suitable mixing vessel and the blend of the second portion of fruit and vegetable (e.g., fruit purees, vegetable purees, concentrated fruit juices, concentrated vegetable juices, or combinations of the foregoing) is added to the blend tank and mixed together with the pre-blend. In certain embodiments, the pre-blend and the blend of the second portion of fruit and vegetable are mixed together for 10 minutes to 30 minutes, preferably for 20 minutes. In certain embodiments, the temperature of the pre-blend and the blend of the second portion of fruit and vegetable during mixing is maintained at from 75° F. to 105° F., preferably the temperature during mixing is maintained at 90° F.

In certain embodiments, at least one of the fruit ingredients or the vegetable ingredients used to make the exemplary pureed nutritional products, whether in puree form or concentrated juice form, is provided for use in a frozen state. In certain embodiments, one or more of the fruit and vegetable ingredients used to make the exemplary pureed nutritional products, whether in puree form or concentrated juice form, is provided for use in an aseptic state. In certain embodiments, at least one of the fruit ingredients or the vegetable ingredients used to make the exemplary pureed nutritional products is provided for use in a frozen state, and one or more of the fruit and vegetable ingredients is provided for use in an aseptic state.

The method of making the pureed nutritional product also includes homogenizing the pureed nutritional product to reduce the particle size of the pureed nutritional product. In certain embodiments, the pureed nutritional product is transferred to a homogenizer to reduce the particle size of the pureed nutritional product. As previously mentioned, in certain embodiments, at least 90% of particles comprising the pureed nutritional product have a particle size of less than 600 or the pureed nutritional product has an average particle size of less than 300 or at least 90% of particles comprising the pureed nutritional product have a particle size of less than 600 μm and the pureed nutritional product has an average particle size of less than 300 In certain embodiments, the homogenizer is a two-stage homogenizer that applies a first-stage pressure of from 1,500 psi to 3,500 psi, preferably 2,500 psi, and a second-stage pressure of 250 psi to 750 psi, preferably 500 psi. By reducing particle size, the homogenization step imparts a smooth texture and mouthfeel to the pureed nutritional product.

After the homogenizing step, the pureed nutritional product is packaged in a container. In certain embodiments, the pureed nutritional product is packaged using a hot-fill processing method. In the hot-fill method the pureed nutritional product is heat treated, such as by passing the pureed nutritional product through a scraped surface heat exchanger and holding at an elevated temperature for a predetermined amount of time. In certain embodiments, the pureed nutritional product is heated to a temperature of 207° F. to 217° F., preferably 212° F., and held at that temperature for 1 minute to 2 minutes, preferably for 1.67 minutes. The heat treated pureed nutritional product is filled while still hot (e.g., 192° F. to 200° F.) in a container, such as a flexible pouch, and sealed with a closure. The container containing the pureed nutritional product is then subjected to an elevated temperature for a predetermined time. In certain embodiments, the container containing the pureed nutritional product is held in a hot water bath having a temperature of greater than 185° F., preferably a temperature of 190° F. to 205° F., for at least 3 minutes, preferably for 3 minutes to 5 minutes. After the container containing the pureed nutritional product is subjected to an elevated temperature for a predetermined time, the container containing the pureed nutritional product is subjected to a lower temperature for a predetermined time to cool the container. In certain embodiments, the container containing the pureed nutritional product is held in a cooling water bath having a temperature of 35° F. to 70° F. for 3 minutes to 5 minutes. In certain embodiments, the container containing the pureed nutritional product is subsequently dried and packaged along with other containers in a carton.

In certain embodiments, the pureed nutritional product is packaged using an aseptic processing method. In an aseptic process, the pureed nutritional product and the container are sterilized separately prior to filling the container with the pureed nutritional product. In certain embodiments, an aseptic process is utilized that includes a high temperature short time (HTST) processing step (e.g., from 160° F. to 175° F. for 15 to 30 seconds) or an ultra high temperature (UHT) processing step (e.g., above 275° F. for 1 to 5 seconds) for sterilizing the pureed nutritional product. In certain embodiments, an aseptic process is utilized that includes sterilizing the container by the application of hydrogen peroxide or other suitable disinfectant to the inside surface of the container. The hydrogen peroxide or other disinfectant may be applied via an atomized mist. To complete the aseptic processing method, the sterilized container is filled with the sterilized pureed nutritional product under aseptic processing conditions and is then sealed with a sterilized closure.

In certain embodiments, the pureed nutritional product is packaged using a retort processing method. An embodiment of a retort processing method may include filling a container with the pureed nutritional product, sealing the container, and then subjecting the sealed, filled container to a heat sterilization step, to form a retort packaged, pureed nutritional product.

### EXAMPLES

The examples that follow illustrate certain exemplary embodiments of the pureed nutritional products described herein. The examples are given solely for the purpose of illustration and are not to be construed as limiting of the present disclosure, as many variations thereof are possible without departing from the spirit and scope of the present disclosure.

The exemplary embodiments of the pureed nutritional products described in Examples 1-4 were prepared in accordance with the methods previously described herein. In particular, the method of making the pureed nutritional products of Examples 1-4 included preparing a pre-blend by mixing together the DHA powder, the vitamin E and lutein premix, and a first portion of a mango puree (Examples 1 and 3) or a first portion of a banana puree (Examples 2 and 4) in a liquefier for about 5 minutes. The pre-blend was then mixed with a blend of a second portion of fruit and vegetable (i.e., the remaining fruit and vegetable ingredients) in a blend tank for approximately 20 minutes at a temperature of about 90° F. to form the pureed nutritional product. The pureed nutritional product was then homogenized using a two-stage homogenizer at a first stage pressure of about 2,500 psi and a second stage pressure at about 500 psi. The homogenized pureed nutritional product was then passed through a scraped surface heat exchanger at about 212° F. and held at this temperature for about 1.5 to 2 minutes. The pureed nutritional product was then filled into a flexible pouch while still hot (e.g., greater than 185° F.) in a flexible pouch and sealed with a cap. The sealed flexible pouch was then held in a water bath at a temperature of greater than 185° F. for at least 3 minutes, and then cooled in a water bath at a temperature of 35° F. to 70° F. for 3 minutes to 5 minutes.

### Example 1

Example 1 illustrates an exemplary embodiment of the pureed nutritional product described herein. All ingredient amounts for Example 1 are listed in Table 1 as kilogram per 1000 kilogram batch of the pureed nutritional product, unless otherwise indicated. The dietary values of the pureed nutritional product of Example 1 are provided in Table 2. The amounts listed in Table 2 are based on a serving size of 114 grams of the pureed nutritional product. The percentage of the daily value (% DV) is based on the recommended daily values for a child of less than 4 years of age.

TABLE 1

| | Example 1 | |
|---|---|---|
| INGREDIENTS | Amount | |
| Mango Puree | 389.5 | kg |
| Apple Puree | 300.0 | kg |
| Butternut Squash Puree | 250.0 | kg |
| Spinach Puree | 50.0 | kg |
| Lemon Juice Concentrate | 7.0 | kg |
| Docosahexaenoic Acid Powder (10% DHA) | 3.5 | kg |
| Vitamin E and Lutein premix | 35.0 | g |
| d-Alpha-Tocopheryl Acetate | 9.1 | g |
| Lutein | 1.2 | g |

| | |
|---|---|
| Maltodextrin | q.s. |

TABLE 2

| Dietary Values | Amount |
|---|---|
| Serving Size, g | 114 |
| Calories, kcal | 60 |
| Protein, g | <1 |
| Carbohydrates, g | 13 |
| Fiber, g | 1 |
| Sugars, g | 10 |
| Fat, g | <1 |
| Docosahexaenoic Acid, mg | 32 |
| Vitamins (% DV) | |
| Vitamin C | 10% |
| Vitamin E | 20% |
| Minerals (% DV) | |
| Calcium | 2% |
| Iron | 2% |

### Example 2

Example 2 illustrates an exemplary embodiment of the pureed nutritional product described herein. All ingredient amounts for Example 2 are listed in Table 3 as kilogram per 1000 kilogram batch of the pureed nutritional product, unless otherwise indicated. The dietary values of the pureed nutritional product of Example 2 are provided in Table 4. The amounts listed in Table 4 are based on a serving size of 114 grams of the pureed nutritional product. The percentage of the daily value (% DV) is based on the recommended daily values for a child of less than 4 years of age.

TABLE 3

| | Example 2 | |
|---|---|---|
| INGREDIENTS | Amount | |
| Butternut Squash Puree | 324.7 | kg |
| Pumpkin Puree | 280.0 | kg |
| Banana Puree | 246.8 | kg |
| Carrot Juice Concentrate | 60.0 | kg |
| Spinach Puree | 50.0 | kg |
| Broccoli Puree | 20.0 | kg |
| Lemon Juice Concentrate | 15.0 | kg |
| Docosahexaenoic Acid Powder (10% DHA) | 3.5 | kg |
| Vitamin E and Lutein premix | 35.0 | g |
| d-Alpha-Tocopheryl Acetate | 9.1 | g |
| Lutein | 1.2 | g |

| | |
|---|---|
| Maltodextrin | q.s. |

TABLE 4

| Dietary Values | Amount |
|---|---|
| Serving Size, g | 114 |
| Calories, kcal | 70 |
| Protein, g | 1 |
| Carbohydrates, g | 14 |
| Fiber, g | 2 |
| Sugars, g | 9 |
| Fat, g | <1 |
| Docosahexaenoic Acid, mg | 32 |
| Vitamins (% DV) | |
| Vitamin C | 2% |
| Vitamin E | 20% |
| Minerals (% DV) | |
| Calcium | 2% |
| Iron | 5% |

### Example 3

Example 3 illustrates an exemplary embodiment of the pureed nutritional product described herein. All ingredient amounts for Example 3 are listed in Table 5 as kilogram per 1000 kilogram batch of the pureed nutritional product, unless otherwise indicated. The dietary values of the pureed nutritional product of Example 3 are provided in Table 6. The amounts listed in Table 6 are based on a serving size of 114 grams of the pureed nutritional product. The percentage of the daily value (% DV) is based on the recommended daily values for a child of less than 4 years of age.

TABLE 5

| | Example 3 | |
|---|---|---|
| INGREDIENTS | Amount | |
| Mango Puree | 369.5 | kg |
| Sweet Potato Puree | 330.0 | kg |
| Pear Puree | 290.0 | kg |
| Lemon Juice Concentrate | 7.0 | kg |
| Docosahexaenoic Acid Powder (10% DHA) | 3.5 | kg |
| Vitamin E and Lutein premix | 35.0 | g |
| d-Alpha-Tocopheryl Acetate | 9.1 | g |
| Lutein | 1.2 | g |

| | |
|---|---|
| Maltodextrin | q.s. |

TABLE 6

| Dietary Values | Amount |
|---|---|
| Serving Size, g | 114 |
| Calories, kcal | 80 |
| Protein, g | <1 |
| Carbohydrates, g | 18 |
| Fiber, g | 2 |
| Sugars, g | 12 |
| Fat, g | <1 |
| Docosahexaenoic Acid, mg | 32 |
| Vitamins (% DV) | |
| Vitamin C | 10% |
| Vitamin E | 20% |
| Minerals (% DV) | |
| Calcium | 2% |
| Iron | 2% |

### Example 4

Example 4 illustrates an exemplary embodiment of the pureed nutritional product described herein. All ingredient amounts for Example 4 are listed in Table 7 as kilogram per 1000 kilogram batch of the pureed nutritional product, unless otherwise indicated. The dietary values of the pureed nutritional product of Example 4 are provided in Table 8. The amounts listed in Table 8 are based on a serving size of 114 grams of the pureed nutritional product. The percentage of the daily value (% DV) is based on the recommended daily values for a child of less than 4 years of age.

TABLE 7

| | Example 4 | |
|---|---|---|
| INGREDIENTS | Amount | |
| Apple Puree | 452.5 | kg |
| Butternut Squash Puree | 310.0 | kg |
| Banana Puree | 150.0 | kg |
| Blueberry Puree | 80.0 | kg |
| Lemon Juice Concentrate | 4.0 | kg |
| Docosahexaenoic Acid Powder (10% DHA) | 3.5 | kg |
| Vitamin E and Lutein premix | 35.0 | g |
| d-Alpha-Tocopheryl Acetate | 9.1 | g |
| Lutein | 1.2 | g |

| | |
|---|---|
| Maltodextrin | q.s. |

TABLE 8

| Dietary Values | Amount |
|---|---|
| Serving Size, g | 114 |
| Calories, kcal | 60 |
| Protein, g | <1 |
| Carbohydrates, g | 13 |
| Fiber, g | 1 |
| Sugars, g | 10 |
| Fat, g | <1 |
| Docosahexaenoic Acid, mg | 32 |
| Vitamins (% DV) | |
| Vitamin C | 2% |
| Vitamin E | 20% |
| Minerals (% DV) | |
| Iron | 2% |

### Example 5

Example 5 illustrates the sensory performance of the pureed nutritional products described in Examples 1 to 4. In this example, the flavor intensity and off-notes of the pureed nutritional products were evaluated.

A panel of certified flavor profilers evaluated the samples for flavor intensity and off-note flavor characteristics. For each pureed nutritional product, there were three sample types that were evaluated. All of the samples used in this example had been stored at about 70° F. to about 75° F. for seven months after initial production. A control sample of the pureed nutritional product was evaluated by tasting the pureed nutritional product directly from a never opened, sealed pouch. A 24-hour sample of the pureed nutritional product was evaluated by tasting the pureed nutritional product from a pouch that was opened and then resealed and refrigerated for 24 hours. A 24-hour tub sample of the pureed nutritional product was evaluated by tasting the pureed nutritional product after the contents of a never opened, sealed pouch were transferred to an open tub container and refrigerated for 24 hours. After tasting, the flavor profilers assessed the flavor intensity and off-note flavor characteristics of each sample and collaborated to reach a consensus using a scoring system set forth in Table 9 below. The consensus results for the sample are shown in Table 10.

TABLE 9

| Scale | Description |
|---|---|
| )( | Threshold |
| ½ | Very Slight |
| 1 | Slight |
| 1½ | Slight to Moderate |
| 2 | Moderate |
| 2½ | Moderate to Strong |
| 3 | Strong |

TABLE 10

| Samples | Flavor Intensity | Off-Notes |
|---|---|---|
| Pureed Nutritional Product | | |
| of Example 1 | | |
| Control | 1½ (pineapple, apple, | )( |
| | green vegetable) | |
| 24-hour | 1½ | )( |
| 24-hour tub | 1½ | ½ (fishy) |
| Pureed Nutritional Product | | |
| of Example 2 | | |
| Control | 1½ (carrot, apple, | )( |
| | root vegetable) | |
| 24-hour | 1½ | )( |
| 24-hour tub | 1½ | 1 (degraded fishy) |
| Pureed Nutritional Product | | |
| of Example 3 | | |
| Control | 1½ (sweet potato, | )( |
| | apple, mango) | |
| 24-hour | 1½ (very slightly | )( (older fruit) |
| | suppressed) | |
| 24-hour tub | 1½ (very slightly | )( (older fruit) |
| | suppressed) | |
| Pureed Nutritional Product | | |
| of Example 4 | | |
| Control | 1½ (apple, | )( |
| | pumpkin, hay) | |
| 24-hour | 1½ | ½ (fish) |
| 24-hour tub | 1½ | ½ (degraded fishy) |

The flavor profilers indicated that no notable differences were detected between the control sample and the 24-hour sample for each type of pureed nutritional product. However, fishy off-notes were detected in the 24-hour tub samples for each type of pureed nutritional product.

### Example 6

Example 6 illustrates the effects of using a homogenization step in the process of making the pureed nutritional product. In this example, two batches of pureed nutritional product according to Example 2 were prepared. The only difference between the two batches was that one batch was prepared using a process that included a homogenization step. In the homogenization step, the pureed nutritional product was processed through a two-stage homogenizer that applied a first-stage pressure of about 2,500 psi and a second-stage pressure of about 500 psi.

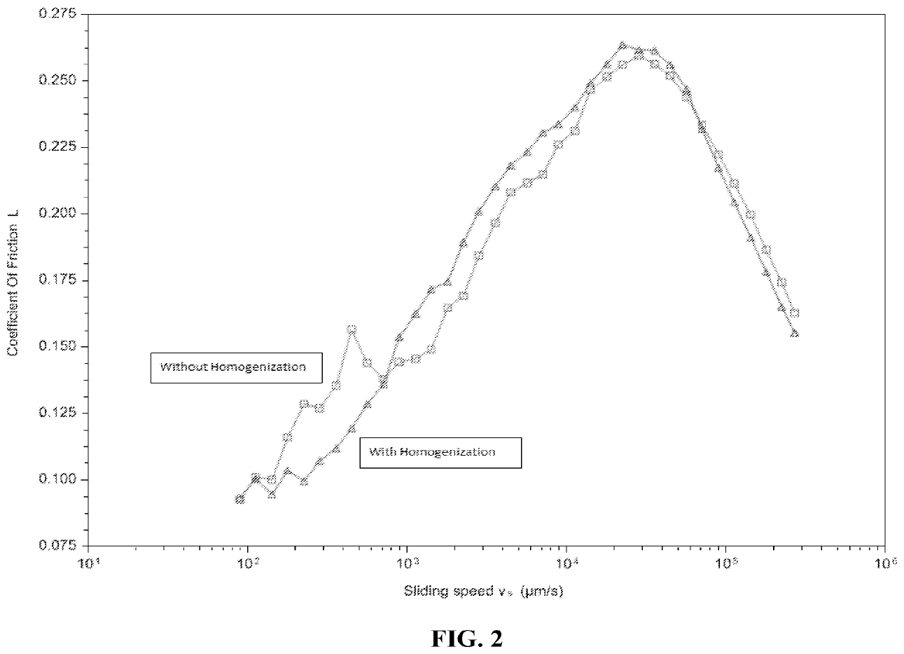

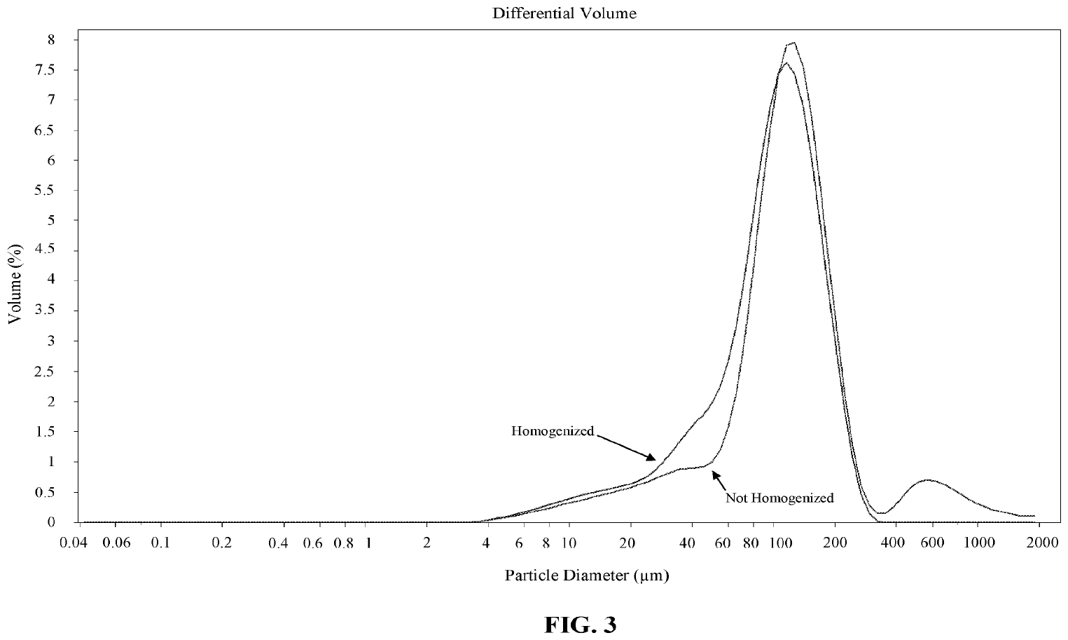

The effects of the homogenization step are illustrated graphically in FIGS. 2 and 3. In FIG. 2, tribology curves are presented that show the change in the coefficient of friction as a function of sliding speed. The tribology of each sample was measured using a Discover HR-3 rheometer with triborheology geometry from TA Instruments (New Castle, Del.). Each sample was placed in a temperature controlled cell with three steel plates. Subsequently, an upper geometry consisting of a rubber ball in a flex mount was lowered until it came into contact with the steel plates at a constant normal force of 3 N. Next, the rotational velocity was ramped up and the coefficient of friction as a function of sliding speed was measured using TRIOS software (TA Instruments, New Castle, Del.).

In the homogenized pureed nutritional product, the coefficient of friction increases steadily without abrupt changes as the sliding speed is increased. On the other hand, the non-homogenized pureed nutritional product shows a few abrupt changes in the coefficient of friction in the sliding speed range of 200 μm/s to 700 μm/s.

A graph showing particle size differences between the homogenized and non-homogenized pureed nutritional product is illustrated in FIG. 3. The particle size was determined using a LSTM 13 320 laser diffraction particle size analyzer from Beckman Coulter Life Sciences (Indianapolis, Ind.). A sample of each pureed nutritional product was diluted directly into a water chamber until a Polarization Intensity Differential Scattering (PIDS) percentage between 40 and 55 was reached. For each sample the volume percent of particles falling below a specified particle diameter was measured and reported, as shown in FIG. 3.

The particle size distribution of the non-homogenized pureed nutritional product shows a bimodal distribution, whereas the homogenized pureed nutritional product shows a unimodal distribution. The homogenized pureed nutritional product also has a smaller average particle size, as can be appreciated from FIG. 3.

The data illustrated in FIGS. 2 and 3 indicates that the homogenized pureed nutritional product will provide a more uniform mouthfeel and a smoother texture and consistency as compared to the non-homogenized pureed nutritional product. Moreover, the data suggests that the homogenized pureed nutritional product will better resist phase separation during storage as compared to the non-homogenized pureed nutritional product.

### Example 7

Example 7 evaluates the particle size characteristics of exemplary embodiments of the pureed nutritional product disclosed herein, specifically Examples 1-4 listed above, as compared to the particle size characteristics of other puree-type products that are commercially available. The particle size data was obtained using a LSTM 13 320 laser diffraction particle size analyzer from Beckman Coulter Life Sciences (Indianapolis, Ind.) as described above in Example 6.

Examples 1-4 were prepared using a process that included a homogenization step. Furthermore, Examples 1-4 were prepared using frozen and aseptic ingredients. Comparative Sample A was a puree-type product that contains banana and butternut squash. Comparative Sample B was a puree-type product that contains carrot, apple, and mango. Comparative Sample C was a puree-type product that contains pear, mango, and spinach. Comparative Sample D was a puree-type product that contains banana, mango, butternut squash, apple, oats, amaranth, quinoa, buckwheat, millet, chia, pineapple, and cinnamon. Comparative Sample E was a puree-type product that contains apple, carrot, spinach, navy beans, oats, and chia. Comparative Sample F was a puree-type product that contains pear, sweet potato, spinach, navy beans, blueberry, milled oats, and chia. The particle size data for each of the various samples is presented in Table 11 below.

TABLE 11

| | Average | Median | | | | |
|---|---|---|---|---|---|---|
| | Particle Size | Particle Size | Standard | | | |
| Sample | (μm) | (μm) | Deviation | d10 (μm) | d50 (μm) | d90 (μm) |
| Example 1 | 197 | 141 | 184 | 45.8 | 141 | 424 |
| Example 1 Duplicate | 191 | 141 | 186 | 46.1 | 141 | 427 |
| Example 2 | 100 | 96.9 | 50.7 | 36.2 | 96.9 | 169 |
| Example 2 Duplicate | 101 | 97 | 50.8 | 36.5 | 97 | 169 |
| Example 3 | 240 | 113 | 371 | 39.9 | 113 | 555 |
| Example 3 Duplicate | 152 | 106 | 155 | 38.5 | 106 | 325 |
| Example 4 | 194 | 150 | 164 | 48.2 | 150 | 398 |
| Example 4 Duplicate | 198 | 152 | 172 | 49.1 | 152 | 402 |
| Comparative Sample A | 109 | 86.2 | 121 | 24.2 | 86.2 | 178 |
| Comparative Sample B | 413 | 311 | 338 | 100 | 311 | 867 |
| Comparative Sample C | 295 | 215 | 250 | 79.8 | 215 | 631 |
| Comparative Sample D | 159 | 110 | 170 | 17.4 | 110 | 372 |
| Comparative Sample E | 414 | 252 | 413 | 68.3 | 252 | 1023 |
| Comparative Sample F | 298 | 191 | 308 | 68.3 | 191 | 684 |

The homogenized pureed nutritional products of Examples 1-4 showed a fairly uniform particle size distribution. Regardless of the formulation, 10% of the total particles were below 50 μm (the d10 value), 50% of the total particles were below 200 μm (the d50 value), and 90% of the particles of the product were below 600 μm (the d90 value). On the contrary, the comparative products showed a wide variation in sizes in the d10, d50, and d90 values. This suggests lack of homogeneity in the particle size of the comparative samples, an indication that homogenization was not performed on the comparative samples. The particle size variations in the comparative samples is likely due to the original particle size variations among the individual ingredients used to make the comparative samples. Furthermore, for Comparative Samples A and D, it is likely that the ingredients used were only aseptic ingredients (which likely undergo homogenization during manufacture of the ingredients) and did not include any frozen ingredients.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the present disclosure, in its broader aspects, is not limited to the specific details, the representative compositions and processes, and illustrative examples shown and described. Accordingly, departures may be made from such details without departing from the spirit or scope of the present disclosure.

1. A pureed nutritional product comprising:
from 50 wt % to 99.7 wt % of a blend of fruit and vegetable;
at least one polyunsaturated fatty acid;
at least one carotenoid; and
RRR-alpha-tocopherol,
wherein the pureed nutritional product has an energy density of 0.4 kcal/g to 0.8 kcal/g.

2. The pureed nutritional product of claim 1, wherein the fruit comprises at least one of: apple; banana; blueberry; mango; pear; strawberry; pineapple; avocado; peach; and lemon; and
the vegetable comprises at least one of: squash; sweet potato; carrot; pumpkin; spinach; kale; broccoli; and zucchini.

3. The pureed nutritional product of claim 1, wherein the pureed nutritional product has less than 0.12 grams of monosaccharides and disaccharides per gram of pureed nutritional product.

4. The pureed nutritional product of claim 1, wherein the pureed nutritional product has from 8 milligrams to 18 milligrams of fiber per gram of the pureed nutritional product.

5. The pureed nutritional product of claim 1, wherein at least 90% of particles comprising the pureed nutritional product have a particle size of less than 600 μm, and the pureed nutritional product has an average particle size of less than 300 μm.

6. The pureed nutritional product of claim 1, wherein the pureed nutritional product has a consistency of 5 cm to 15 cm per 30 seconds.

7. The pureed nutritional product of claim 1, wherein the at least one polyunsaturated fatty acid comprises docosahexaenoic acid.

8. The pureed nutritional product of claim 7, wherein the pureed nutritional product comprises from 0.1 mg to 0.5 mg of docosahexaenoic acid per gram of pureed nutritional product.

9. The pureed nutritional product of claim 1, wherein the at least one carotenoid comprises lutein.

10. The pureed nutritional product of claim 1, further comprising an acidity regulator.

11. The pureed nutritional product of claim 1, wherein the pureed nutritional product has a pH of 3.8 to 4.6.

12. The pureed nutritional product of claim 1, further comprising from 6 mg to 120 mg of protein per gram of pureed nutritional product.

13. The pureed nutritional product of claim 12, further comprising from 6 mg to 60 mg of protein per gram of pureed nutritional product.

14. The pureed nutritional product of claim 12, wherein at least a portion of the protein is a whey protein.

15. A packaged nutritional product comprising:
a sealed container having an interior volume;
a pureed nutritional product disposed within the interior volume of the container, the pureed nutritional product comprising:
from 50 wt % to 99.7 wt % of a blend of fruit and vegetable;
at least one polyunsaturated fatty acid;
at least one carotenoid; and
RRR-alpha-tocopherol,
wherein the pureed nutritional product has an energy density of 0.4 kcal/g to 0.8 kcal/g.

16. The packaged nutritional product of claim 15, wherein the fruit comprises at least one of: apple; banana; blueberry; mango; pear; strawberry; pineapple; avocado; peach; and lemon; and
the vegetable comprises at least one of: squash; sweet potato; carrot; pumpkin; spinach;
kale; broccoli; and zucchini.

17. The packaged nutritional product of claim 15, wherein the pureed nutritional product has less than 0.12 grams of sugar per gram of pureed nutritional product.

18. The packaged nutritional product of claim 15, wherein at least 90% of particles comprising the pureed nutritional product have a particle size of less than 600 μm, and the pureed nutritional product has an average particle size of less than 300 μm.

19. The packaged nutritional product of claim 15, wherein the pureed nutritional product has a consistency of 5 cm to 15 cm per 30 seconds.

20.-24. (canceled)

25. The packaged nutritional product of claim 15, wherein the sealed container comprises a flexible pouch having a spout in fluid communication with the interior volume and a closure configured to releasably engage the spout.

26.-29. (canceled)
